(19) United States
(12) Patent Application Publication
(10) Pub. No.: US 2014/0366066 A1
(43) Pub. Date: Dec. 11, 2014

(54) METHOD AND SYSTEM FOR PROVIDING BROADCAST PROGRAM RECOMMENDATIONS IN A DIGITAL TELEVISION SYSTEM

(71) Applicants: Ranjith Ramakrishnan, Palakkad (IN); Nisa Kadavath Sasipanicker, Ernakulam (IN); Liju George, Kottayam (IN)

(72) Inventors: Ranjith Ramakrishnan, Palakkad (IN); Nisa Kadavath Sasipanicker, Ernakulam (IN); Liju George, Kottayam (IN)

(73) Assignee: WIPRO LIMITED, Bangalore (IN)

(21) Appl. No.: 13/960,967

(22) Filed: Aug. 7, 2013

(30) Foreign Application Priority Data
Jun. 6, 2013 (IN) 2495/CHE/2013

(51) Int. Cl. H04N 21/482

(52) U.S. Cl. CPC H04N 21/4826
USPC 725/46

(57) ABSTRACT

The disclosure generally relates to media broadcast technologies, and more specifically relates to a method and system for providing broadcast program recommendations in a digital television system. In one embodiment, a processor-implemented broadcast program recommendation method is disclosed, comprising: storing a user profile including a user interest pattern; tuning to a program channel not currently provided for display, using a tuner; extracting a snippet from the program channel; comparing, using a processor, the snippet with the user interest pattern, to identify a match; determining that the match is valid; and providing by the processor a notification of the match. The user interest pattern may comprise at least one of: a still image, a video clip, an audio clip, and a text pattern. The user profile may be created via selecting at least the user interest pattern from one of: a network source; and a user device.

### PRIORITY CLAIM

This disclosure claims priority under 35 U.S.C. §119 to: India Application No. 2495/CHE/2013, filed Jun. 6, 2013, and entitled “METHOD AND SYSTEM FOR PROVIDING BROADCAST PROGRAM RECOMMENDATIONS IN A DIGITAL TELEVISION SYSTEM.” The aforementioned application is incorporated herein by reference in its entirety.

### TECHNICAL FIELD

The disclosure generally relates to media broadcast technologies, and more specifically relates to a method and system for providing broadcast program recommendations in a digital television system.

### BACKGROUND

Advancement in technologies, such as media processing, signaling, TCP/IP, satellite communications and many other related areas, have led to improved delivery of AV signal to consumers. Thus, consumers and viewers are now spoilt for choices with numerous programs. Programs now run over diverse media and are available from diverse sources and are concurrently available to the consumers for their recreation and satisfaction.

In a typical digital TV, it is not uncommon to have hundreds of program channels which cater to various demographics. On the one hand, the numerous choices are a boon for consumers due to the varied range of programs available. However, on the other hand, choosing and tuning into a program of choice out of the numerous options available has become a difficult task for the consumer on account of the sheer number of channels available. Trying to find a program channel of interest may involve the consumer cycling through the large number of program channels until a favorable channel is found. This is both time consuming and frustrating for the consumer.

Electronic Program Guides (EPG) that list out the various broadcast programs scheduled on the various program channels help the consumer to a certain extent to find a program of interest. The consumer may go over the EPG to locate a program of interest. However, trying to find a program of interest using the EPG has the same drawbacks as cycling through the program channels to find a program of interest. The effort to go through the significantly high number of entries corresponding to the large number of program channels could be time intensive and also lead to frustration of the consumer.

To ease the efforts required by the consumer, certain EPGs allow the consumer to search the EPG using one or more keywords to find a program of interest. However, oftentimes consumers may not have a definite idea as to what they would like to watch and hence may not come up with relevant keywords with which to query the EPG. Further, if keyword searches on the EPG do not retrieve accurate results, the consumer may be hesitant to use the search option in future.

Other methods of recommending broadcast programs to a consumer may involve creating a profile for the consumer that includes age, sex, location, and preferences of the consumer such as genre of interest, sports of interest, favorite programs or favorite actors. Based on these parameters, one or more broadcast programs may be automatically suggested to the consumer by comparing these parameters with the metadata associated with the broadcast programs. However, the number of programs suggested based on these parameters may be quite large and inaccurate and the consumer may have to again go through the result set to determine a program or channel of interest.

### SUMMARY

In one embodiment, a processor-implemented broadcast program recommendation method is disclosed, comprising: storing a user profile including a user interest pattern; tuning to a program channel not currently provided for display, using a tuner; extracting a snippet from the program channel; comparing, using a processor, the snippet with the user interest pattern to identify a match; determining that the match is valid; and providing by the processor a notification of the match. The user interest pattern may comprise at least one of: a still image, a video clip, an audio clip, and a text pattern. The user profile may be created via selecting at least the user interest pattern from one of: a network source; and a user device. The method may further comprise: modifying the user profile using a user interest pattern variation. The method may further comprise: receiving a priority value for the user interest pattern. Tuning to the program channel may comprise tuning to the program channel for a predefined period of time. The program channel may be selected based on user input. The snippet may comprise at least one of: a still image, a video clip, an audio clip, and a text pattern. The method may further comprise: filtering matches based on a user input. Validity of the match may be determined based on whether the match is associated with an advertisement or a broadcast program. Sometimes, validity of the match may be determined based on a user criterion.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 illustrates an exemplary television broadcast environment in which various embodiments function.

FIG. 2 illustrates a flowchart of a broadcast program recommendation method in accordance with some embodiments.

FIG. 3 illustrates a flowchart of an exemplary method of selecting one or more program channels to extract snippets in accordance with some embodiments.

FIG. 4 illustrates a block diagram of a broadcast program recommendation apparatus in accordance with some embodiments.

### DETAILED DESCRIPTION

Now, exemplary embodiments of the present disclosure will be described with reference to the accompanying drawings. Wherever possible, the same reference numbers will be used throughout the drawings to refer to the same or like parts. While exemplary embodiments and features are described herein, modifications, adaptations, and other implementations are possible, without departing from the spirit and scope of the disclosure. Accordingly, the following detailed description does not limit the subject matter. Instead, the proper scope of the subject matter is defined by the appended claims.

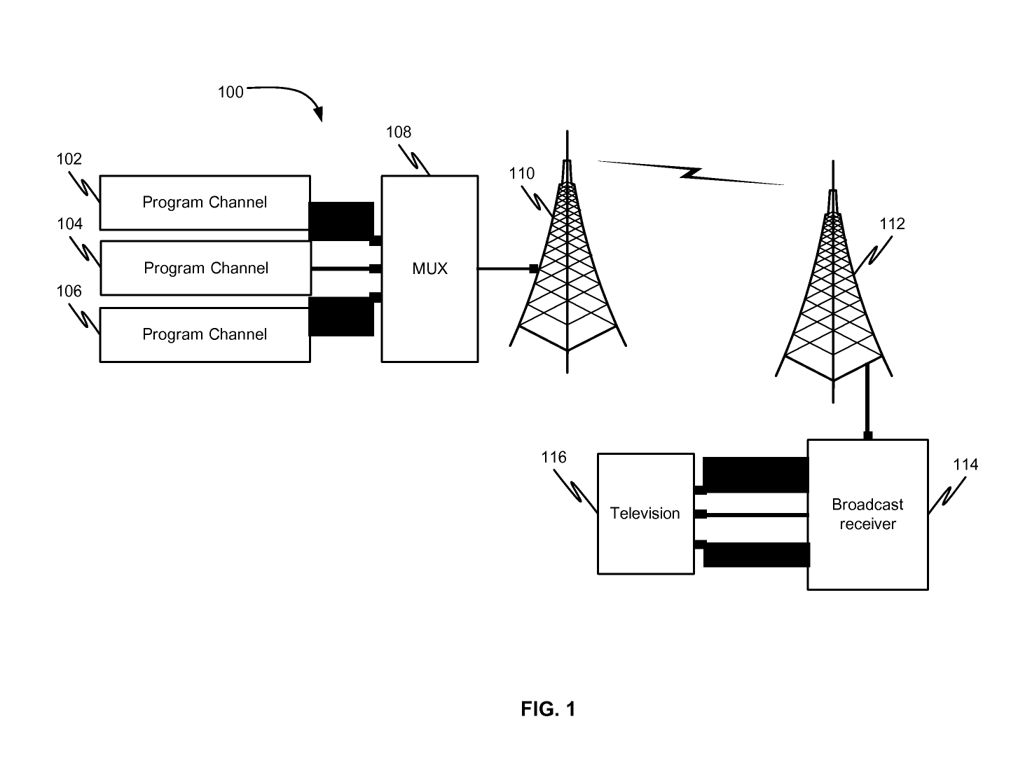

FIG. 1 illustrates an exemplary television broadcast environment 100 in which various embodiments function. Television broadcast environment 100 may include, on a broadcaster side, a number of program channels such as a program channel 102, a program channel 104, and a program channel 106 that are multiplexed into one or more transport streams using a Multiplexer (Mux) 108. Although FIG. 1 illustrates three program channels 102-106, it will be apparent to a person skilled in the art that any number of program channels may be multiplexed into one or more transport streams. A transport stream is a multiplexed stream that may include video packets, audio packets, and data packets that contain program specific information and other associated information. One or more transport streams may be transmitted at a particular frequency by a broadcasting station 110 and may include one or more channels or services which in turn may include one or more broadcast programs.

The one or more transport streams transmitted by broadcasting station 110 may be received by a receiver antenna 112 associated with a broadcast receiver 114. Broadcast receiver 114 may then demultiplex the incoming one or more transport streams and provide the demultiplexed signals to a television 116 to be displayed. Broadcast receiver 114 may tune to a frequency associated with a desired program channel to display the program channel (e.g., regular continuous programming, video-on-demand (VOD), video-in-demand (VID), pay-per-view (PPV), etc.). Although, FIG. 1 illustrates broadcast receiver 114 as being separate from television 116, it should be noted that this is for purposes of illustration only and broadcast receiver 114 may be a part of television 116. In an exemplary embodiment, broadcast receiver 114 may be a set-top box. Other examples of the broadcast receiver 114 may include, without limitation, a desktop computer, laptop computer, tablet, smartphone, personal wearable device (such as Google Glass™), radio, or the like. Similarly, television 116 may, in some embodiments, be any audio or audiovisual system that is operatively connected to or integrated with any of the aforementioned example broadcast receivers.

Television broadcast environment 100 is a generic representation of a broadcast system and may be configured to include, but not limited to, a terrestrial broadcast system; a cable broadcast system, and a satellite broadcast system, or any combinations thereof. In a terrestrial broadcast configuration, broadcast station 110 may transmit broadcast signals (examples of broadcast approaches include, without limitation: client/server, peer-to-peer (P2P), periodic, etc.) associated with the program channels over the air into a surrounding area. These broadcast signals may be received by a receiver antenna such as receiver antenna 112. On receiving the broadcast signals, a broadcast receiver such as broadcast receiver 114 associated with the receiver antenna may process the broadcast signals to render the program channels. For example, the broadcast receiver may decrypt incoming audiovisual data packets, de-multiplex broadcast program channels, decode/decompress a program channel, re-format the audiovisual data packets for display and provide the data for display to a display screen.

Television broadcast environment 100 may also be configured to support a cable broadcast system. In this configuration, the broadcast signals transmitted by broadcast station 110 may be received by one or more common antennas (not shown in FIG. 1), as opposed to a receiver antenna associated with each broadcast receiver. The broadcast signals may be then distributed from the common antenna to each broadcast receiver via cables.

In another example configuration, broadcast environment 100 may include one or more satellites orbiting the Earth (not shown in FIG. 1). In this case, broadcast station 110 may transmit the broadcast signals to the one or more orbiting satellites. The one or more satellites then may re-transmit the broadcast signals back to the Earth. These re-transmitted broadcast signals may be picked up by a parabolic antenna associated broadcast receiver 114 and may then be processed to obtain the broadcast content.

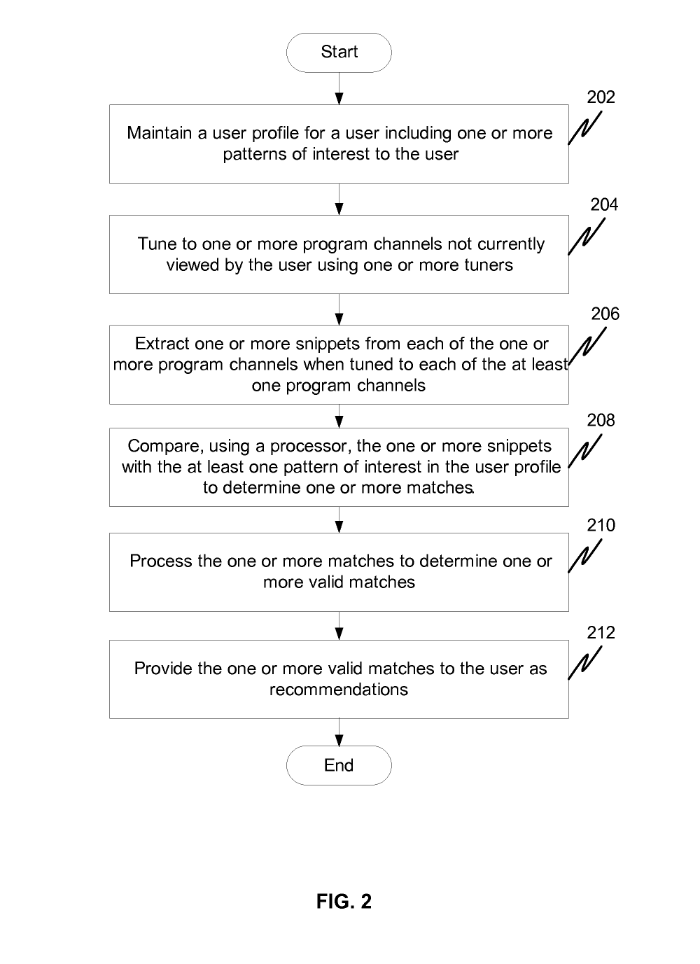

A method of providing broadcast program recommendations to a user in a digital television system in accordance with some embodiments will now be described in conjunction with FIG. 2. The method may include storing a user profile of the user at step 202, the profile including one or more patterns that are of interest to the user. For example, the user profile may be implemented in a relational database management system (RBDMS) that may be interacted with using commands such as structured query language (SQL) commands. Here, a pattern of interest to the user may include, but is not limited to, a still image, a video clip, an audio clip or a text pattern. The user may initially create the profile by selecting and saving user interested patterns. For example, the user may include the image or photo of a favorite actor or a favorite animal in the user profile. Similarly, short audio clips and video clips may also be included in the user profile. In some embodiments, the user may populate the user profile with patterns selected from internet sources. For example, when the user browses web pages and comes across images that are of interest, the user may add the images to the user profile. If the digital television is capable of accessing the internet, the user may be provided an interface on the television to search for patterns of interest and save them in the profile. However, if the television does not have a connection to the internet, the user may download patterns of interest into a storage device and subsequently transfer these patterns to be saved in the user profile. In some other embodiments, the user may transfer images, audio clips, video clips or text patterns from a personal device to the user profile over one of a wireless and a wired link. It will be apparent to a person skilled in the art that various offline and online mechanisms may be used to create the user profile without deviating from the scope of the disclosure.

In addition to the patterns selected by the user to form the user profile, variations of the patterns may be determined and added to the profile. The most frequently watched programs of a user may be determined and snippets from the mostly watched programs may be compared with the entries in the user profile to find similar patterns. If a certain percentage of match is found between the snippets and the entries in the profile, the snippets may be added to the profile. In order to prevent the exact same patterns as the existing profile patterns from being added, a threshold may be set such that any pattern having a matching percentage above the threshold may be discarded. The threshold may be set by the user or a default value may be set. The similar patterns may be determined and added to the profile automatically or based on confirmation from the user. In some embodiments, the user may use an image from the profile to find similar images by performing an image search on a search engine by using the image in the profile. The results produced as a result of the image search may be included in the user profile by the user.

The user may further provide priority levels to the patterns in the profile. The user may assign a priority to each of the patterns in the user profile based on a level of relevance or importance of the patterns to the user. The priority associated with each of the patterns is used to determine the priority of the notifications provided to the user as will be explained later.

Accordingly, example data fields that may be part of a user interest pattern record of a user profile include, without limitation: user ID, device ID, pattern type, pattern source, pattern data, timestamp(s) (e.g., date created, last updated, last accessed, last matched), pattern frequency, pattern duration (e.g., seconds) or pattern length (e.g., bits), priority level (e.g., weighting factor(s)), pattern match threshold(s), pattern keyword(s), pattern variations list, metadata types, metadata content, related record(s) ID(s), notification settings, and/or the like.

Referring back to FIG. 2, at step 204, one or more tuners may be used to tune to one or more program channels, e.g., selected from among those not currently provided for display. The one or more tuners may be in addition to a tuner used to tune to the program channel currently being provided for display. To elaborate, one or more second tuners may be used to tune (e.g., automatically, or using user input) to the one or more channels in the background while a first tuner is tuned to the currently provided channel. When the one or more second tuners are tuned to the one or more channels, one or more snippets may be extracted from each of the one or more program channels at step 206. Here, a snippet may correspond to one of a still image, a video clip, an audio clip or a text pattern. A snippet associated with a program channel may be extracted by extracting one or more frames associated with the broadcast signal corresponding to the program channel.

In some embodiments, each transport stream broadcasted by a broadcaster may be associated with a tuner on the receiver side to tune to that transport stream. Thus, in these embodiments, there may be as many tuners in a broadcast receiver as there are transport streams transmitted by the broadcaster. In this case, various program channels may be tuned in parallel and accordingly snippets may be extracted in parallel. In some other embodiments, a single second tuner may be used to tune to the one or more channels not currently provided for display. The single second tuner may tune to a program channel for a predefined period (e.g., specified in terms of number of second, or amount of data captured or extracted) during which one or more snippets from the program channel may be captured or extracted. This may be repeated cyclically for all other channels of the one or more program channels. The predefined period may be specified by the user or may be a default setting.

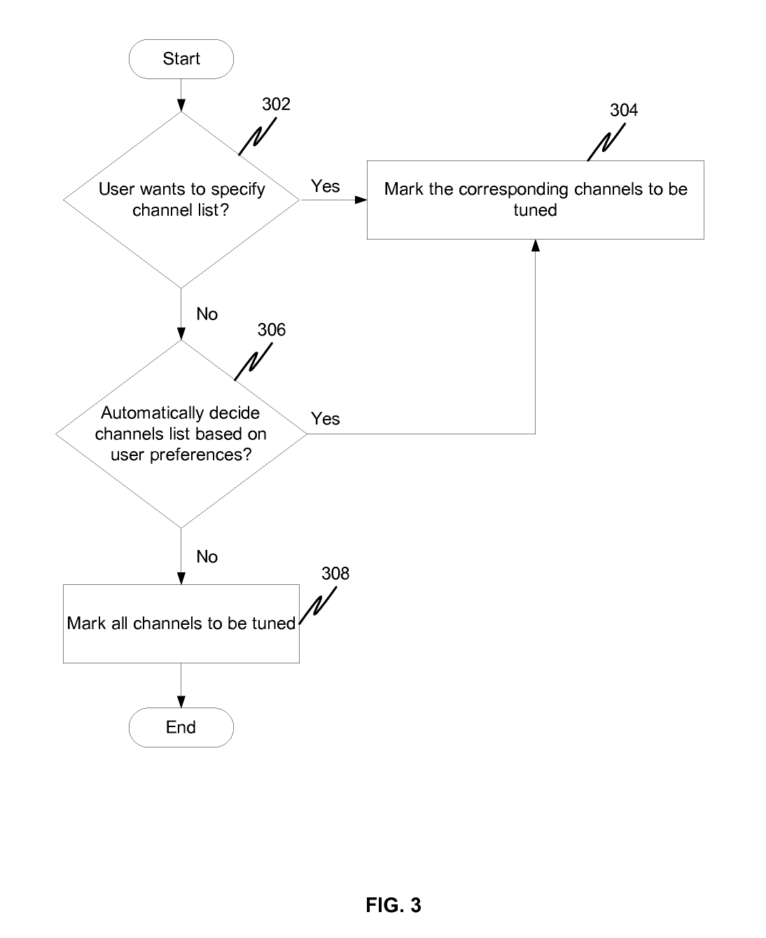

The one or more program channels to be tuned to extract snippets may be selected automatically or by the user as explained in conjunction with FIG. 3. At step 302, the user may be provided an option of specifying a list of channels to be tuned. If the user wishes to provide a channel list, then the corresponding channels are marked at step 304. Accordingly, only the marked channels may be tuned in order to extract snippets. The marked channels may be tuned by maintaining a broadcasting stack that stores the details of different channels like the frequency of each channel, the Program information, PID details, etc. These details may be used for tuning and collecting frames from each of the channels. When the user selects the one or more channels to be tuned, the frequencies associated with these channels may be communicated to the one or more second tuners. The one or more second tuners may accordingly tune to the frequencies associated with the selected channels. The user may select any subset of the available program channels or may select all the program channels to be tuned. If the user does not wish to make a selection of the channels to be tuned, then at step 306, it may be verified if the channel list may be determined automatically. If the user indicates that the channel list is to be determined automatically, then the channel list to be tuned may be automatically created based on the preferences of the user. In some embodiments, the patterns saved in the user profile may be analyzed to identify preferences of the user. For example, if the user has populated the user profile with a number of images of animals, then it may be inferred that the user is an animal lover and accordingly wildlife channels may be automatically selected to be tuned. In other embodiments, the program channel subscriptions availed by the user may be considered when automatically determining channels of interest to the user. For example, if the user has subscribed to a large number of movie channels and very few sports channels, then it may be inferred that the user prefers movies over sports and accordingly, movie channels may be automatically selected to be tuned. If the channels of interest to the user can be determined automatically, then control may go back to step 304 wherein the channels of interest are marked to be tuned. If it is not possible to automatically determine the channel list due to lack of information or due to any other factors then, by default, all the channels may be tuned at step 308 to extract snippets from each of the channels.

On extracting snippets from the one or more program channels, the extracted snippets may be compared against the patterns in the user profile at step 208 to determine one or more matches. If the extracted snippet is an image, then the extracted image is compared with all the images in the user profile to check for a match. For example, such matching may be performed using image comparison technologies similar to those utilized by web search engines to determine similarity, or semantic relevance, of other images to a target image. An example of such technology is described in Chechik et al., “Large scale online learning of image similarity through ranking,” Journal of Machine Learning Research, vol. 11, pp. 1109-1135 (2010), the entire contents of which are incorporated herein by reference. Similarly, audio and video snippets may also be compared with audio and video patterns in the user profile. For example, in the case of audio, comparisons may be performed through frequency analysis or audio fingerprinting. An example of such technology is described in Cano et al., “A review of algorithms for audio fingerprinting,” 2002 IEEE Workshop on Multimedia Signal Processing, pp. 169-173. (2002), the entire contents of which are incorporated herein by reference. It is to be understood that for identifying matches, any known pattern matching method may be used. The one or more matches identified as a result of the comparison may be temporarily stored in a buffer for a predefined period of time. Thereafter, at step 210, the one or more matches may be processed to determine one or more matches that are valid. In other words, the validity of a match determined at step 208 may be verified by performing one or more processing steps. Notifications of the matches which are valid may then be provided as recommendations at step 212. In some embodiments, matches which are valid may be determined by excluding matches corresponding to advertisements or commercials. If the broadcast channel is showing an advertisement when the snippet is captured and this snippet matches a pattern in the profile, then this scenario could lead to a false positive. Such matches may not be provided to the user as recommendations of broadcast programs. In some embodiments, advertisements or commercial breaks in between a broadcast program may be determined based on splicing information associated with the broadcast program. A splice information table may provide the times at which commercial breaks are scheduled and the duration of the commercial breaks. This information may be used to determine if a match corresponds to an advertisement/commercial or to a broadcast program. In some other embodiments, occurrence of a series of ‘black’ video frames simultaneously accompanied by a decrease in the audio signal in an extracted snippet may indicate that a commercial break is beginning In further embodiments, an extracted snippet may be compared against an advertisement repository maintained by a broadcaster to determine if the extracted snippet corresponds to an advertisement. It will be apparent to a person skilled in the art that any method for determining if a snippet corresponds to an advertisement or a jingle may be employed without deviating from the scope of the disclosure.

In some embodiments, a match between a snippet extracted from a broadcast channel and a pattern in the user profile may be considered valid when one or more criteria specified by the user is satisfied. A user may indicate a preference associated with a pattern in the user profile and when the preference is satisfied along with the match then such a match may be considered a valid match. For example, the user may have an image of Arnold Schwarzenegger in the profile. The user may then specify that any matches related to Arnold Schwarzenegger should also relate to movies for the match to be valid. In this case, any matches relating to Arnold Schwarzenegger and relating to politics or to bodybuilding contests may not be considered valid and hence such recommendations may not be provided to the user. Similarly, the user may specify that any matches corresponding to broadcast programs that are almost ending need not be shown. In this case, the user may set a threshold such that if the program has passed the threshold mark, that program should not be recommended to the user. In some embodiments, if the broadcast program associated with a match has already ended or is almost ending, then a notification corresponding to the next broadcast time of that broadcast program may be provided to the user. Alternatively, one or more alternate broadcast programs that are similar to the broadcast program associated with the match may be suggested to the user. The alternate broadcast programs may be programs that are currently being broadcasted or those that are scheduled to be broadcasted at a later time.

The matches which are valid may be provided to the user in accordance with the priorities associated with the patterns in the user profile. For example, if the user has assigned a higher priority to a Pattern 1 than to a Pattern 2 and valid matches for both Pattern 1 and Pattern 2 were found, then the valid match corresponding to Pattern 1 would be provided with higher priority than the valid match for Pattern 2. In some embodiments, the valid match corresponding to Pattern 1 may be placed higher in a list of matches than the match for Pattern 2 when provided to the user. In some other embodiments, the match for Pattern 1 may be assigned a different color than the match for Pattern 2 to indicate the difference in priorities. It will be apparent to a person skilled in that art that various visual representations may be used to depict various priority levels without deviating from the scope of the disclosure.

When the valid matches are provided to the user, the user may be allowed to provide one or more inputs to filter the valid matches. In some embodiments, the user may be allowed to provide one or more dynamic queries to filter down the number of valid matches to a more relevant set. The processing of the queries may be performed only on the valid matches and hence the time taken for providing a result set for the query is minimized. For example, the user may use Boolean operators to add more relevant keywords or patterns to refine the result set. For example, if a large number of results are returned that correspond to program channels that match an image of a Tiger, then the user may add a restriction such as Tiger AND Lion using keywords to filter the result set to those channels whose snippets match both Tiger and Lion. In some other embodiments, the user may form a query by choosing one or more additional patterns from the profile. In keeping with the previous example, the user may drag and drop an image of a Lion from the profile to indicate that matches corresponding to both a Tiger and a Lion are preferred. Other known methods of querying the set of valid matches may be used without deviating from the spirit of the disclosure.

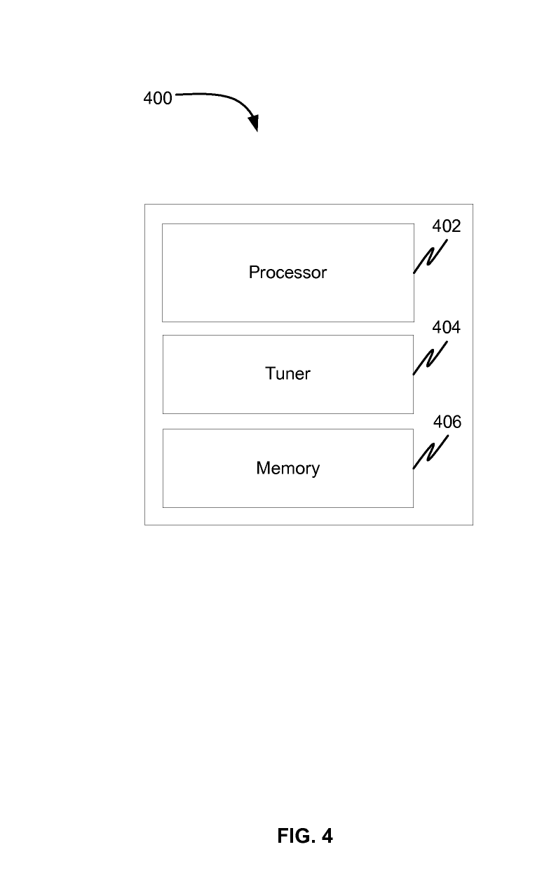

Moving on to FIG. 4, an apparatus 400 for providing broadcast program recommendations to a user is disclosed. Apparatus 400 may include one or more processors such as processor 402, one or more tuners such as tuner 404 and a memory 406 storing instructions to be executed by the one or more processors. Memory 406 may further store a user profile for the user. The user profile may include one or more user interested patterns. In some embodiments, a pattern may include, but is not limited to, a still image, a video clip, an audio clip and a text pattern. The user may initially create the profile by selecting and saving patterns that are of interest to the user. Creation of the user profile is explained in detail in conjunction with FIG. 2.

Processor 402 may further be configured by instructions to cause one or more tuners such as tuner 404 to tune to one or more program channels currently not provided for display. Tuner 404 may be in addition to a tuner used to tune to the program channel currently being provided for display. That is, a first tuner (not shown in FIG. 4) may be used to tune to the currently provided channel while tuner 404 tunes to the one or more program channels in the background. Tuner 404 may tune to each of the program channels not provided for display for a predefined period of time and extract snippets from the program channels as explained in conjunction with FIG. 2. In some embodiments, the user may control what channels are to be tuned to extract snippets by specifying the channels that are to be tuned. Alternatively, in some embodiments, processor 402 may be configured to automatically determine what channels to tune based on one or more preferences of the user. In some embodiments, processor 402 may analyze patterns saved in the user profile to identify preferences of the user. In other embodiments, the program channel subscriptions availed by the user may be considered when automatically determining channels of interest to the user. If processor 402 is unable to automatically determine what channels to tune or if the user so chooses, all the channels not currently provided for display may be tuned to extract snippets from each of the channels.

On extracting snippets from the user's desired program channels, processor 402 may compare the extracted snippets with the patterns in the user profile to determine one or more matches. If the extracted snippet is an image, then the extracted image is compared with all the images in the user profile to check for a match. Similarly, audio and video snippets may also be compared with audio and video patterns in the user profile. The one or more matches identified as a result of the comparison may be temporarily stored in memory 406 for a predefined period of time. Thereafter, processor 402 may perform one or more processing operations on the one or more matches to determine one or more matches that are valid. In some embodiments, valid matches may be determined by excluding matches corresponding to advertisements or commercials. In some other embodiments, a match between a snippet extracted from a broadcast channel and a pattern in the user profile may be considered valid when one or more criteria specified by the user is satisfied as elaborated in conjunction with FIG. 2.

After determining the valid matches, processor 402 may provide notifications of the valid matches to the user. The valid matches may be provided to the user in accordance with the priorities associated with the patterns in the user profile as explained in conjunction with FIG. 2. In some embodiments, the user may provide one or more inputs to filter the valid matches provided. In some embodiments, the user may be allowed to provide one or more dynamic queries to filter down the number of valid matches to a more relevant set. Processor 402 may be configured by instructions to receive the user input and process the input against the set of valid matches to refine the result set to the most relevant matches for the user. These matches may then be provided to the user as recommendations of broadcast programs that may be of interest to the user.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A processor-implemented broadcast program recommendation method, comprising:
storing a user profile including a user interest pattern;
tuning to a program channel not currently provided for display, using a tuner;
extracting a snippet from the program channel;
comparing, using a processor, the snippet with the user interest pattern, to identify a match;
determining that the match is valid; and
providing by the processor a notification of the match;

2. The method of claim 1, wherein the user interest pattern comprises at least one of: a still image, a video clip, an audio clip, and a text pattern.

3. The method of claim 1, wherein the user profile is created via selecting at least the user interest pattern from one of: a network source; and a user device.

4. The method of claim 1, further comprising: modifying the user profile using a user interest pattern variation.

5. The method of claim 1, further comprising: receiving a priority value for the user interest pattern.

6. The method of claim 1, wherein tuning to the program channel comprises tuning to the program channel for a predefined period of time.

7. The method of claim 1, wherein the program channel is selected based on user input.

8. The method of claim 1, wherein the snippet comprises at least one of: a still image, a video clip, an audio clip, and a text pattern.

9. The method of claim 1, further comprising: filtering matches based on a user input.

10. The method of claim 1, wherein validity of the match is determined based on whether the match is associated with an advertisement or a broadcast program.

11. The method of claim 1, wherein validity of the match is determined based on a user criterion.

12. A broadcast program recommendation apparatus, comprising:
at least one processor;
at least one tuner; and
a memory storing instructions executable by the at least one processor, the instructions comprising instructions to:
store a user profile including a user interest pattern;
tune to a program channel not currently provided for display, using the at least one tuner;
extract a snippet from the program channel;
compare the snippet with the user interest pattern, to identify a match;
determine that the match is valid; and
provide a notification of the match.

13. The apparatus of claim 12, wherein the user interest pattern comprises at least one of: a still image, a video clip, an audio clip, and a text pattern.

14. The apparatus of claim 12, wherein creating the user profile comprises selecting at least the user interest pattern from one of: a network source; and a user device.

15. The apparatus of claim 12, the instructions further comprising instructions to: modify the user profile using a user interest pattern variation.

16. The apparatus of claim 12, wherein tuning to the program channel comprises tuning to the program channel for a predefined period of time.

17. The apparatus of claim 12, the instructions further comprising instructions to: automatically select the program channel based on a user preference.

18. The apparatus of claim 12, the instructions further comprising instructions to: receive a user selection of the program channel.

19. The apparatus of claim 12, wherein the snippet comprises at least one of: a still image, a video clip, an audio clip, and a text pattern.

20. The apparatus of claim 12, the instructions further comprising instructions to: filter matches based on a user input.

21. The apparatus of claim 12, wherein validity of the match is determined based on whether the match is associated with an advertisement or a broadcast program.

22. The apparatus of claim 12, wherein validity of the match is determined based on a user criterion.
